(19) United States
(12) Patent Application Publication
(10) Pub. No.: US 2013/0155019 A1
(43) Pub. Date: Jun. 20, 2013

(54) Touchpad Protection

(71) Applicant: Affiliated Computer Services Solutions France S.A.S., Guilherand Granges (FR)

(72) Inventors: Marion Froment, Guilherand-Granges (FR); Guillaume Le Bidan, Guilherand-Granges (FR)

(73) Assignee: Affiliated Computer Services Solutions France S.A.S., Guilherand Granges (FR)

(21) Appl. No.: 13/720,742

(22) Filed: Dec. 19, 2012

(30) Foreign Application Priority Data
Dec. 19, 2011 (FR) 1161884

(51) Int. Cl. G06F 1/16

(52) U.S. Cl. CPC G06F 1/1656
USPC 345/174; 345/173

(57) ABSTRACT

A user interface device including a touchpad behind a protection plate, behind which the touchpad can freely shift with respect to the protection plate, along an axis perpendicular to the protection plate.

### CROSS-REFERENCE TO RELATED APPLICATIONS

The present application claims priority to French patent application No. 1161884 filed Dec. 19, 2011.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Field of the Invention

The present disclosure relates to devices provided with a user interface device comprising a touchpad, for example a touchscreen. It more specifically aims at devices intended to be installed in public premises, and in particular at transport ticket processing devices such as automatic transport ticket machines, transport ticket readers, transport ticket validation terminals, etc.

2. Discussion of the Related Art

A disadvantage of equipment comprising a touchpad, and in particular of equipment intended to be installed in public premises, is the fragility of the pad. Indeed, the touchpad generally comprises a relatively thin glass panel capable of breaking in case of a shock. To overcome this disadvantage, it is known to place the touchpad behind a transparent protection glass made of a shock-resistant material, such as polycarbonate.

However, to avoid transmitting to the touchpad possible shocks affecting the glass, the pad is generally separated from the glass. This adversely affects the display and the sensitivity of the user interface.

### SUMMARY

Thus, an object of an embodiment of the present invention is to provide a user interface device comprising a touchpad, this device at least partly overcoming some of the disadvantages of known devices.

Another object of an embodiment of the present invention is to provide a user interface device comprising a touchpad, this device having an increased resistance to shocks with respect to known devices.

Another object of an embodiment of the present invention is to provide a user interface device comprising a touchpad, this device having an increased performance, and in particular an improved touch sensitivity with respect to known devices.

Another object of an embodiment of the present invention is to provide a user interface device comprising a display screen, this device having an increased resistance to shocks and an improved display performance with respect to known devices.

Thus, an embodiment of the present invention provides a user interface device comprising a touchpad behind a protection plate, behind which the touchpad can freely shift with respect to the protection plate, along an axis perpendicular to the protection plate.

According to an embodiment of the present invention, resilient return means maintain the touchpad against the protection plate.

According to an embodiment of the present invention, the resilient return means comprise at least one spring.

According to an embodiment of the present invention, the spring is a helical metal spring.

According to an embodiment of the present invention, the protection plate is maintained by a frame attached to a package of the device, where the touchpad can freely shift with respect to the package.

According to an embodiment of the present invention, the protection plate is a transparent glass.

According to an embodiment of the present invention, the touchpad is attached to a support which can freely shift perpendicularly to the protection plate.

According to an embodiment of the present invention, the support is assembled to freely shift along slides arranged perpendicularly to the protection plate.

According to an embodiment of the present invention, the touchpad is a projected capacitive touchpad.

Another embodiment of the present invention is to provide a device for processing transport tickets comprising a user interface device of the above-mentioned type.

The foregoing and other features and advantages of the present invention will be discussed in detail in the following non-limiting description of specific embodiments in connection with the accompanying drawings.

### BRIEF DESCRIPTION OF THE DRAWINGS

FIGS. 1A and 1B are cross-section views very schematically illustrating an example of a usual device equipped with a user interface device comprising a touchpad; and

FIGS. 2A and 2B are cross-section views schematically illustrating an embodiment of a device equipped with a user interface device comprising a touchpad.

### DETAILED DESCRIPTION

For clarity, the same elements have been designated with the same reference numerals in the different drawings and, further, the various drawings are not to scale. Further, only those elements which are useful to the understanding of the present invention have been shown and described. In particular, neither the functions of devices equipped with a touchpad, nor the means used to perform these functions, have been detailed, the described embodiments being compatible with any type of device equipped with a user interface device comprising a touchpad (automatic transport ticket machine, transport ticket reader, interactive information panel, etc.).

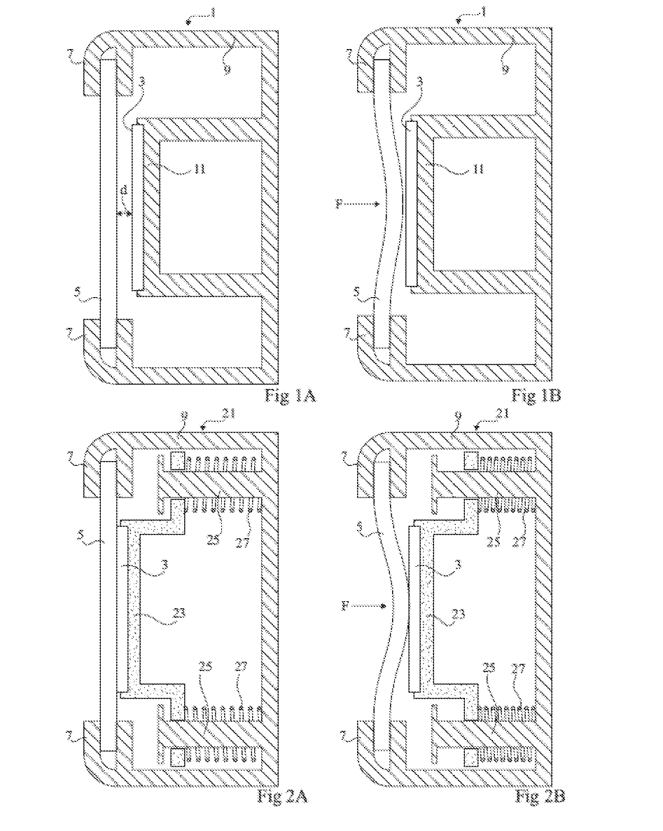

FIGS. 1A and 1B are cross-section views very schematically illustrating an example of a device 1 equipped with a user interface device comprising a touchpad 3. A protection glass 5, for example, made of polycarbonate, is arranged in front of touchpad 3, in a plane parallel to the plane of touchpad 3. Touchpad 3 is manufactured in a technology enabling to detect touches through protection glass 5. A projected capacitive touchpad is for example used. Glass 5 is maintained by a frame 7 attached to a package 9 of the device. Touchpad 3 is maintained by a support 11 rigidly connected to package 9.

As appears in FIG. 1A, touchpad 3 is not placed against protection glass 5. A guard distance d is provided between touchpad 3 and glass 5, to avoid for a possible shock received by protection glass 5, for example, in the case where glass 5 is hit by a vandal, to be directly transmitted to touchpad 3, which could damage it, even if this blow does not break glass 5.

As shown in FIG. 1B, protection glass 5 may have a non-negligible flexibility, especially when it is made of a synthetic material, such as polycarbonate. Thus, the application of a force F perpendicularly to glass 5, for example, in case of a blow on glass 5, may cause, at least temporarily, a deformation of glass 5. Guard distance d between touchpad 3 and glass 5 must be selected by taking into account the glass deformation capacity, so when the glass is hit, it does not crush the touchpad against support 11, which would risk damaging the touchpad.

A disadvantage is that the guard distance provided between touchpad 3 and protection glass 5 adversely affects the performance of the user interface device, and especially its touch sensitivity. Decreasing the guard distance is however not desirable since this would amount to decreasing the shock resistance of the device.

Another disadvantage is that in case of a particularly violent shock, the deformation of glass 5 may be such that, despite guard distance d, glass 5 crushes touchpad 3 against support 11 and damage the pad.

FIGS. 2A and 2B are cross-section views schematically illustrating an embodiment of a device 21 equipped with a user interface device comprising a touchpad 3.

A transparent protection glass 5 made of a shock-resistant material, for example, polycarbonate, is arranged in front of touchpad 3. Possibly, and if this is compatible with the operation of touchpad 3, an opaque plate made of a shock-resistant material may replace transparent glass 5. In particular, if the touchpad is not associated with a display screen, the protection plate does not need to be transparent. Touchpad 3 is formed in a technology enabling to detect touches through protection glass 5 (or, possibly, through an opaque protection plate), for example, a projected capacitive technology. In the shown example, touchpad 3 and protection glass 5 are approximately planar, and are arranged in substantially parallel planes.

Protection glass 5 is for example maintained by a frame 7 attached to a package 9 of the device (or forming one piece with package 9).

According to an aspect of the described embodiment, in a normal configuration of use of the device, touchpad 3 can freely shift with respect to protection glass 5, along an axis approximately perpendicular to glass 5. Phrase “in a normal configuration of use of the device” here means that the device is in its normal mechanical operating configuration, that is, that all possible covers or maintenance accesses of the device are in closed and locked position. In particular, this phrase is intended to exclude the case where, for device maintenance operations, a system of access to the touchpad may be provided, where the protection glass could laterally slide along an axis perpendicular to the touchpad, along rails (or other shifting guide means) to enable an intervention by a technician.

In the shown example, glass 5 being rigidly attached to frame 7, itself rigidly attached to the package, touchpad 3 can freely shift with respect to frame 7 and to package 9. In this example, touchpad 3 is attached to a support 23, for example, an element of plastic material, support 23 being itself freely assembly with respect to glass 5, along an axis approximately perpendicular to the plane of glass 5.

In an embodiment, guide means 25, for example, column-shaped slides, are attached to package 9, slides 25 being arranged perpendicularly to protection glass 5. Support 23 is assembled to slide on guide means 25, for example, via circular openings formed in support 23, and where slides 25 may freely slide in translation. Guide means 25 are provided to ensure that touchpad 3 has no other degree of liberty than that of shifting perpendicularly to glass 25. In particular, guide means 25 are provided to ensure that the touchpad always remains approximately parallel to protection glass 5.

As can be seen in FIG. 2B, an advantage of such an assembly is that in case of a shock, and especially when a force F is applied to glass 5, perpendicularly to the glass, touchpad 3 is not damaged, and this, even if the glass deforms enough to come into contact with the touchpad. Indeed, in this case, the touchpad is simply pushed back towards the inside of the device, by shifting of support 23 along slides 25. The touchpad thus is not submitted, as in the example described in relation with FIGS. 1A and 1B, to stress capable of damaging it, by crushing between protection glass 5 and the touchpad support (support 11 of FIGS. 1A and 1B).

An advantageous consequence of such an assembly is that it is no longer necessary to provide a guard distance between touchpad 3 and protection glass 5. Anyway, if a guard distance is however provided, it may be significantly decreased with respect to an assembly of the type described in relation with FIGS. 1A and 1B. This enables to improve the performance of the user interface of the device, and especially its touch sensitivity.

In a preferred embodiment illustrated in FIGS. 2A and 2B, resilient return means are provided to maintain touchpad 3 against protection plate 5 (substantially no guard distance). In the shown example, springs 27, for example, helical metal springs, are arranged parallel to slides 25 of support guide 23. Springs 27 are compressively mounted between support 23 on the one hand, and the bottom of device 9 of the device on the other hand, on the side of touchpad 3 opposite to the protection glass. Thereby, springs 27 maintain touchpad 3 against protection glass 5, or close to protection glass 5, a short guard distance, for example, depending on the shape of support 23, which may also remain (in this case, support 23 is maintained against protection glass 5 or against frame 7 for holding the glass).

The stiffness of the resilient return means will be selected by taking into account the fragility of the touchpad and the force of the blows capable of being received by protection glass 5. In particular, the return means will be selected to be adapted so that the force necessary to push back touchpad 3 when glass 5 is hit, to be lower than the maximum stress that touchpad 3 can withstand.

The provision of resilient return means has a double advantage. In normal operation, they enable to maintain touchpad 3 as close as possible to protection glass 5, which improves the touch sensitivity of the device. And in case of a shock having caused a temporary deformation of the protection glass and a backward motion of the touchpad, they enable to automatically bring the touchpad back to its position, for example, bearing against the protection glass, without requiring an intervention by a technician.

Of course, it will be within the abilities of those skilled in the art to provide any other adapted arrangement of the resilient return means, to obtain the desired operation.

Another advantage of the embodiment described in relation with FIGS. 2A and 2B is that it has an increased resistance to shocks with respect to a device of the type described in relation with FIGS. 1A and 1B. Indeed, in the embodiment described in relation with FIGS. 1A and 1B, the resistance to shocks is limited by guard distance d, guard distance d being itself limited by the distance from which the touchpad can no longer be actuated (touchpad sensitivity). In the device described in relation with FIGS. 2A and 2B, a shock, even very strong, may cause a significant backward motion of touchpad 3, but will not result in damaging it.

Specific embodiments of the present invention have been described. Various alterations, modifications, and improvements will readily occur to those skilled in the art.

In particular, the described embodiments are not limited to the case where the touchpad uses a projected capacitive technology. Any other touch technology capable of being actuated through a protection plate may be used.

Further, an embodiment where touchpad 3 and protection plate 5 are substantially planar has been described hereabove. It will be within the abilities of those skilled in the art to adapt the above-described embodiment to a device comprising a non-planar touch surface and a non-planar protection surface, for example, parallel to the touch surface. In this case, the axis along which the touch surface is assembled to freely shift may be orthogonal to the median plane of the protection surface, or orthogonal to one of the planes tangent to the protection surface.

Further, in relation with FIGS. 2A and 2B, an embodiment of a device where a protection glass 5 is maintained by a frame 7 attached to a package 9 of the device has been described. The described embodiments are however not limited to this specific configuration. For example, package 9 may itself be attached to an armature of the device, frame 7 and guide means 25 being indirectly attached to package 9 by being attached to the device armature. It will be within the abilities of those skilled in the art to implement the desired operation whatever the mechanical configuration of the device.

Further, the described embodiments are not limited to the example described in relation with FIGS. 2A and 2B, where the guide means are column-shaped slides. It will be within the abilities of those skilled in the art to adapt the described embodiment by using other guide means, for example, rails, slides, etc. As a variation, the guide means and the resilient return means may be confounded.

Further, a touchpad protection has been described hereabove. It will be within the abilities of those skilled in the art to adapt the described embodiments to the protection of a touchscreen (for example, intended to be installed in public premises), or to other electronic devices.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A user interface device comprising:
a protection plate; and
a touchpad behind the protection plate, wherein the touchpad can freely shift with respect to the protection plate along an axis perpendicular to the protection plate.

2. The device of claim 1, wherein a resilient return maintains the touchpad against the protection plate.

3. The device of claim 2, wherein the resilient return comprises at least one spring.

4. The device of claim 3, wherein the spring is a helical metal spring.

5. The device of claim 1, further comprising:
a package; and
a frame attached to the package,
wherein the protection plate is maintained by the frame, and
wherein the touchpad can freely shift with respect to the package.

6. The device of claim 1, wherein the protection plate is a transparent glass.

7. The device of claim 1, further comprising a support, wherein the touchpad is attached to the support and can freely shift perpendicularly to the protection plate.

8. The device of claim 7, wherein the support is assembled to freely shift along a plurality of slides arranged perpendicular to the protection plate.

9. The device of claim 1, wherein the touchpad is a projected capacitive touchpad.

10. The device of claim 1, wherein the device is configured to process transport tickets.

11. The device of claim 2, further comprising:
a package; and
a frame attached to the package,
wherein the protection plate is maintained by the frame, and
wherein the touchpad can freely shift with respect to the package.

12. The device of claim 3, further comprising:
a package; and
a frame attached to the package,
wherein the protection plate is maintained by the frame, and
wherein the touchpad can freely shift with respect to the package.

13. The device of claim 4, further comprising:
a package; and
a frame attached to the package,
wherein the protection plate is maintained by the frame, and
wherein the touchpad can freely shift with respect to the package.
